(19) United States
(12) Patent Application Publication
(10) Pub. No.: US 2024/0204272 A1
(43) Pub. Date: Jun. 20, 2024

(54) BATTERY CONTROL SYSTEM FOR PREVENTING CELL IMBALANCE AND OPERATING METHOD THEREOF

(71) Applicant: LG ENERGY SOLUTION, LTD., Seoul (KR)

(72) Inventor: Jae Hyung KIM, Daejeon (KR)

(73) Assignee: LG ENERGY SOLUTION, LTD., Seoul (KR)

(21) Appl. No.: 18/287,157

(22) PCT Filed: Dec. 23, 2022
(86) PCT No.: PCT/KR2022/021205

§ 371 Date: Oct. 16, 2023

(30) Foreign Application Priority Data
Mar. 31, 2022 (KR) 10-2022-0040370

(51) Int. Cl. H01M 10/48; H01M 10/44

(52) U.S. Cl. CPC H01M 10/486; H01M 10/443; H01M 10/482

(57) ABSTRACT

A battery control system may comprise: a temperature measuring device for measuring a temperature of a first battery cell disposed at a first point among a plurality of battery cells included in a battery assembly and a temperature of a second battery cell disposed at a second point among the plurality of battery cells, wherein the second point being spaced apart from the first point; and a controller for monitoring the temperature of the first battery cell and the temperature of the second battery cell and performing a predefined control operation for preventing state degradation due to temperature imbalance among the battery cells based on at least one of the temperature of the first battery cell and the temperature of the second battery cell.

### TECHNICAL FIELD

This application claims priority to and the benefit of Korean Patent Application No. 10-2022-0040370 filed in the Korean Intellectual Property Office on Mar. 31, 2022, the entire contents of which are incorporated herein by reference.

The present invention relates to a battery control system and a method for controlling the battery control system, and more particularly, to a battery control system for preventing state deterioration due to temperature imbalance among the battery cells and a method for controlling the battery control system.

### BACKGROUND ART

A secondary battery is a battery that can be recharged and reused even after being discharged, which may be used as an energy source for small devices such as mobile phones, tablet PCs, and vacuum cleaners and also used as an energy source for medium-to-large devices such as electric vehicles and an energy storage system for smart grids.

The secondary battery is applied to a system as a form of an assembly such as a battery module in which a plurality of battery cells are connected in series and parallel or a battery pack in which battery modules are connected in series and parallel according to system requirements.

A plurality of battery cells included in the battery assembly may have different external temperature environments depending on a seating position according to a system design, and thus, an imbalance problem may occur among cells in which performance and deterioration speeds of respective cells are different as the battery cells operate at different temperatures. In particular, if a battery cell operating in a high-temperature environment is fully charged and then trickle-charged due to current consumption of the system, performance degradation and deterioration are accelerated, and an imbalance among battery cells in the battery assembly may further intensify.

### DETAILED DESCRIPTION OF THE INVENTION

### Technical Problem

To obviate one or more problems of the related art, embodiments according to an object of the present disclosure provide a battery control system for preventing degradation of state due to temperature imbalance between battery cells.

To obviate one or more problems of the related art, embodiments according to another object of the present disclosure provide a battery control apparatus for preventing degradation of state due to temperature imbalance between battery cells.

To obviate one or more problems of the related art, embodiments according to another object of the present disclosure provide a control method of a battery control system for preventing degradation of state due to temperature imbalance between battery cells.

### Technical Solution

In order to achieve the objective of the present disclosure, a battery control system may comprise: a temperature measuring device configured to measure a temperature of a first battery cell disposed at a first point among a plurality of battery cells included in a battery assembly and a temperature of a second battery cell disposed at a second point among the plurality of battery cells, wherein the second point being spaced apart from the first point; and a controller configured to monitor the temperature of the first battery cell and the temperature of the second battery cell and to perform a predefined control operation for preventing state degradation due to temperature imbalance among the battery cells based on at least one of the temperature of the first battery cell and the temperature of the second battery cell.

The first point may correspond to a point having a higher instantaneous temperature value or a higher average temperature value than that of the second point.

The first point may correspond to a point having the highest instantaneous temperature value or the highest average temperature value in the battery assembly and the second point may correspond to a point having the lowest instantaneous temperature value or the lowest average temperature value within the battery assembly.

The controller may be configured to perform the predefined control operation according to whether or not the at least one of a first condition and a second condition is satisfied, wherein the first condition is a condition in which the temperature of the first battery cell exceeds a predefined upper temperature limit and the second condition is a condition in which a difference between the temperature of the first battery cell and the temperature of the second battery cell exceeds a predetermined reference difference value.

The controller may be configured to: in the instance that an event satisfying at least one of the first condition and the second condition occurs while the plurality of battery cells are being charged, perform a first control operation of lowering a full charge voltage of the plurality of battery cells to a predetermined voltage value.

The controller may be configured to: in the instance that an event in which at least one of the satisfied conditions while the plurality of battery cells are being charged is released occurs after the first control operation, increase the lowered full charge voltage value to a predefined voltage value.

The controller may be configured to: in the instance that an event satisfying at least one of the first condition and the second condition occurs in a fully charged state of the plurality of battery cells, perform a second control operation to block trickle charge for the plurality of battery cells.

The controller may be configured to: in the instance that an event in which at least one of the satisfied conditions is released occurs in a state in which the trickle charge for the plurality of battery cells is blocked, after the second control operation, allow trickle charge for the plurality of battery cells.

According to another embodiment of the present disclosure, a battery control apparatus connected with a temperature measuring device configured to measure a temperature of a first battery cell disposed at a first point among a plurality of battery cells included in a battery assembly and a temperature of a second battery cell disposed at a second point among the plurality of battery cells, wherein the second point being spaced apart from the first point, the apparatus may comprise: at least one processor; and a memory configured to store at least one instruction executed by the at least one processor.

The at least one instruction may include: an instruction to monitor the temperature of the first battery cell and the temperature of the second battery cell; and an instruction to perform a predefined control operation for preventing state degradation due to temperature imbalance between the battery cells based on at least one of the temperature of the first battery cell and the temperature of the second battery cell.

The first point may correspond to a point having a higher instantaneous temperature value or a higher average temperature value than that of the second point.

The first point may correspond to a point having the highest instantaneous temperature value or the highest average temperature value in the battery assembly and the second point may correspond to a point having the lowest instantaneous temperature value or the lowest average temperature value within the battery assembly.

The instruction to perform a predefined control operation may include an instruction to: perform the predefined control operation according to whether or not the at least one of a first condition and a second condition is satisfied, wherein the first condition is a condition in which the temperature of the first battery cell exceeds a predefined upper temperature limit and the second condition is a condition in which a difference between the temperature of the first battery cell and the temperature of the second battery cell exceeds a predetermined reference difference value.

The instruction to perform a predefined control operation may include an instruction to: in the instance that an event satisfying at least one of the first condition and the second condition occurs while the plurality of battery cells are being charged, perform a first control operation of lowering a full charge voltage of the plurality of battery cells to a predetermined voltage value.

The instruction to perform a predefined control operation may include an instruction to: in the instance that an event in which at least one of the satisfied conditions while the plurality of battery cells are being charged is released occurs, after the first control operation, increase the lowered full charge voltage value to a predefined voltage value.

The instruction to perform a predefined control operation may include an instruction to: in the instance that an event satisfying at least one of the first condition and the second condition occurs in a fully charged state of the plurality of battery cells, perform a second control operation to block trickle charge for the plurality of battery cells.

The instruction to perform a predefined control operation may include an instruction to: in the instance that an event in which at least one of the satisfied conditions is released occurs in a state in which the trickle charge for the plurality of battery cells is blocked, after the second control operation, allow trickle charge for the plurality of battery cells.

According to another embodiment of the present disclosure, a control method of a battery control system including a temperature measuring device configured to measure a temperature of a first battery cell disposed at a first point among a plurality of battery cells included in a battery assembly and a temperature of a second battery cell disposed at a second point among the plurality of battery cells, wherein the second point being spaced apart from the first point, and a control apparatus configured to perform a predefined control operation based on the temperature of the first battery cell and the temperature of the second battery cell, the method may comprise: monitoring the temperature of the first battery cell and the temperature of the second battery cell; and performing a predefined control operation for preventing state degradation due to temperature imbalance between the battery cells based on at least one of the temperature of the first battery cell and the temperature of the second battery cell.

The performing a predefined control operation may include: performing the predefined control operation according to whether or not the at least one of a first condition and a second condition is satisfied, wherein the first condition is a condition in which the temperature of the first battery cell exceeds a predefined upper temperature limit and the second condition is a condition in which a difference between the temperature of the first battery cell and the temperature of the second battery cell exceeds a predetermined reference difference value.

The performing a predefined control operation may include: in the instance that an event satisfying at least one of the first condition and the second condition occurs while the plurality of battery cells are being charged, performing a first control operation of lowering a full charge voltage of the plurality of battery cells to a predetermined voltage value.

The performing a predefined control operation may further include: in the instance that an event in which at least one of the satisfied conditions while the plurality of battery cells are being charged is released occurs, after the first control operation, increasing the lowered full charge voltage value to a predefined voltage value.

The performing a predefined control operation may include: in the instance that an event satisfying at least one of the first condition and the second condition occurs in a fully charged state of the plurality of battery cells, performing a second control operation to block trickle charge for the plurality of battery cells.

The performing a predefined control operation may include: in the instance that an event in which at least one of the satisfied conditions is released occurs in a state in which the trickle charge for the plurality of battery cells is blocked, after the second control operation, allowing trickle charge for the plurality of battery cells.

### Advantageous Effects

According to embodiments of the present disclosure, it is possible to prevent state deterioration due to temperature imbalance among battery cells which operate in different temperature environments due to a seating position of a battery assembly.

In addition, according to embodiments of the present invention, it is possible to prevent performance degradation and accelerated deterioration of battery cells operating in a high-temperature environment due to trickle charging.

### BRIEF DESCRIPTION OF THE DRAWINGS

FIG. 1 shows a plurality of battery cells included in a battery assembly;

FIG. 2 illustrates a temperature imbalance state among a plurality of battery cells in a battery assembly;

FIG. 3 is a block diagram of a battery control system according to embodiments of the present invention;

FIG. 4 is an operation flowchart of a control method of a battery control system according to an embodiment of the present invention;

FIG. 5 is an operation flowchart of a control method of a battery control system according to another embodiment of the present invention; and

FIG. 6 is a block diagram of a battery control apparatus according to embodiments of the present invention.

### BEST MODE

The present invention may be modified in various forms and have various embodiments, and specific embodiments thereof are shown by way of example in the drawings and will be described in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes combinations of a plurality of associated listed items or any of the plurality of associated listed items.

It will be understood that when an element is referred to as being “coupled” or “connected” to another element, it can be directly coupled or connected to the other element or an intervening element may be present. In contrast, when an element is referred to as being “directly coupled” or “directly connected” to another element, there is no intervening element present.

The terms used herein is for the purpose of describing specific embodiments only and are not intended to limit the present invention. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Some terms used herein are defined as follows.

A battery cell refers to a minimum unit that serves to store power and a battery module refers to an aggregate of a plurality of battery cells connected in series and parallel.

A battery pack or battery rack refers to a system of a minimum single structure assembled by connecting modules set by a battery manufacturer in series/parallel, which can be monitored and controlled by a battery management system (BMS), and may include several battery modules and a battery protection unit or any other protection device.

A battery bank refers to a group of large-scale battery rack systems configured by connecting a plurality of racks in parallel. A bank BMS for a battery bank may monitor and control several rack BMSs, each of which manages a battery rack.

A battery assembly may include a plurality of electrically connected battery cells and refers to an assembly that functions as a power supply source by being applied to a specific system or device. Here, the battery assembly may mean a battery module, a battery pack, a battery rack, or a battery bank, but the scope of the present invention is not limited to these entities.

State of Charge (SOC) refers to a current state of charge of a battery, represented in percent points [%], and State of Health (SOH) may be a current condition of a battery compared to its ideal or original conditions, represented in percent points [%].

A nominal capacity (Nominal Capa.) refers to a capacity [Ah] of a battery set during development by a battery manufacturer.

Hereinafter, exemplary embodiments of the present invention will be described in detail with reference to the accompanying drawings.

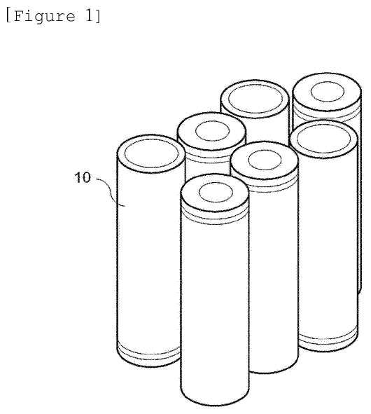

FIG. 1 shows a plurality of battery cells included in a battery assembly.

A plurality of battery cells 10 are connected in series and parallel according to requirements of a system or device to form a battery assembly.

As shown in FIG. 1, the battery cell 10 may be applied to a cylindrical battery, but the scope of the present invention is not limited to the shape type of the battery cell, and may be applied to a pouch-shaped battery or a prismatic battery.

Each of the battery cells 10 may be seated in a battery holder and then accommodated in a battery case so that the battery cells 10 may be spaced apart from each other and arranged at predetermined positions.

The battery case may have an air inlet hole or an air outlet hole to cool the battery cells 10 accommodated therein.

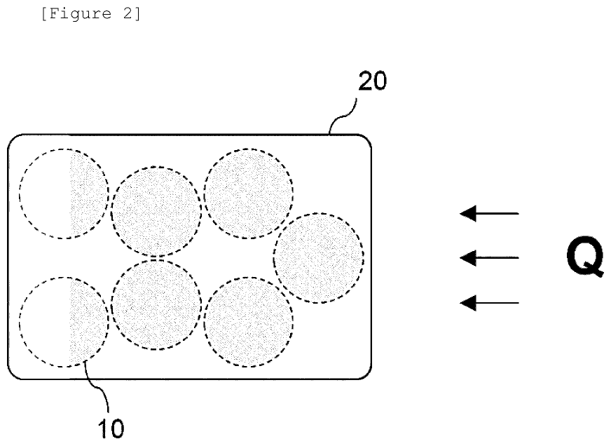

FIG. 2 illustrates a temperature imbalance state between a plurality of battery cells in a battery assembly.

The battery assembly 20 is seated in a specific location according to a system or device design. Here, a temperature imbalance may occur among battery cells 10 due to a design structure and operations of the system to which the battery assembly 20 is applied.

For example, as shown in FIG. 2, when a device generating thermal energy Q is disposed near the battery assembly 20, a battery cell disposed close to the device operates in a high-temperature environment and battery cells disposed far away from the device operate in a relatively low-temperature environment.

In addition, when an operating mode (e.g., strong, medium, or weak) of a device (e.g., a motor) that generates thermal energy Q is changed as needed, operating temperatures of the battery cells 10 continuously vary.

If temperature imbalance occurs among battery cells due to the design structure and operations of the system, performances and deterioration rates of the battery cells become different as the battery cells continuously operate in different temperature environments, and eventually the lifespan of the battery assembly 20 may be shortened. In addition, when trickle charging proceeds due to current consumption of the system after fully charging the battery, trickle charging at a high temperature accelerates performance degradation and deterioration of the battery cells 10, thereby further intensifying imbalance among battery cells.

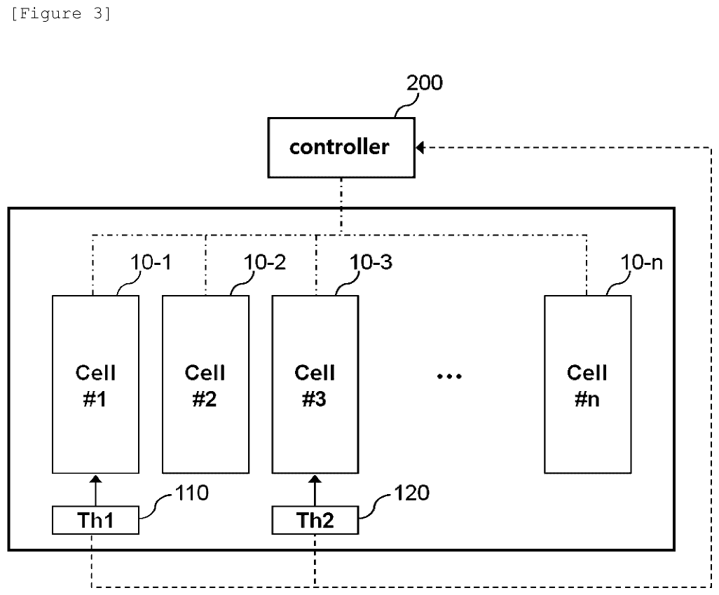

Hereinafter, with reference to FIGS. 3 to 6, various embodiments of the present invention for preventing battery cells from deteriorating due to temperature imbalance will be described.

FIG. 3 is a block diagram of a battery control system according to embodiments of the present invention.

A battery control system according to embodiments of the present invention may include temperature measuring units 110, 120 and a controller 200 as shown in FIG. 3. Here, the temperature measuring units 110 and 120 may measure the temperatures of the plurality of battery cells 10-1, 10-2, . . . , 10-n, and the controller 200 may monitor the measured temperatures to determine when temperature imbalance occurs and to perform a corresponding control operation.

The temperature measuring units 110 and 120 may be configured to measure temperatures of some battery cells among the plurality of battery cells 10-1, 10-2, . . . , 10-n. The battery control system according to the present invention can simplify a control process and improve data processing efficiency by performing control measures to prevent state degradation based on temperatures of some battery cells without monitoring the temperature of all battery cells.

The temperature measurement unit may include a first temperature sensor 110 and a second temperature sensor 120. Here, the first temperature sensor 110 may measure a temperature of the first battery cell 10-1 disposed at the first point and the second temperature sensor 120 may measure a temperature of the second battery cell 10-3 which is disposed at a second point spaced apart from the first point.

The first point may correspond to a point indicating a higher instantaneous temperature value or a higher average temperature value than that of the second point. In other words, in FIG. 3, the first battery cell 10-1 corresponds to a battery disposed in a higher temperature environment than the second battery cell 10-3, and the temperature measurement units may be configured to measure temperatures of the respective battery cells 10-1 and 10-3.

Here, the first point may correspond to a point showing the highest instantaneous temperature value or the highest average temperature value within the battery assembly 20, and the second point may correspond to a point showing the lowest instantaneous temperature or the lowest average temperature value within the battery assembly 20. In other words, the first temperature sensor 110 may be configured to measure the temperature of the battery cell 10-1 disposed in the highest temperature environment, and the second temperature sensor 120 may be configured to measure the temperature of the battery cell 10-3 disposed in the lowest temperature environment.

Here, the first and second points may be determined by measuring temperature values per unit time for all battery cells 10-1, 10-2, . . . , 10-n included in the battery assembly 20 through a preliminary temperature measurement test, and comparing instantaneous temperature values or average temperature values of respective battery cells 10-1, 10-2, . . . , 10-n.

The controller 200 may receive temperature measurement values of the first battery cell 10-1 and the second battery cell 10-3 from the first and second temperature sensors 110 and 120, and monitor temperatures of the first battery cell 10-1 and the second battery cell 10-3.

The controller 200 may determine whether a temperature imbalance among the battery cells has occurred based on the temperature values of the first battery cell 10-1 and the second battery cell 10-3. Here, the controller 200 may determine that a temperature imbalance between battery cells has occurred if at least one of conditions is satisfied, wherein the conditions include: a first condition in which the temperature T1 of the first battery cell 10-1 exceeds a predefined upper temperature limit value Tmax (T1>Tmax); and a second condition in which a difference between the temperature T1 of the first battery cell 10-1 and the temperature T2 of the second battery cell 10-3 exceeds a predefined reference difference value Td (T1−T2>Td).

When a temperature imbalance among battery cells occurs, the controller 200 may perform different control operations according to operating states of the battery cells.

In a process of charging the battery cells, when an event that satisfies at least one of the first condition (T1>Tmax) and the second condition (T1−T2>Td) occurs, the controller 200 may perform a first control operation of lowering the full charge voltage for a plurality of battery cells to a predefined voltage value may be performed. In other words, when a temperature imbalance occurs during a charge process of the battery cells, the controller 200 may minimize performance imbalance of the battery cells by reducing the full charge voltage values of all battery cells (for example, from 5V to 4.10V). Here, the adjusted value of the full charge voltage may be determined based on at least one of the first battery temperature value (T1), the difference between the first and second battery temperatures (T1−T2), a state of the battery (e.g., SOC or SOH), and a number of temperature imbalance occurrences. For instance, the full charge voltage value may be adjusted to a lower value as the first battery temperature value (T1) or the difference between the first and second battery temperatures (T1−T2) increases, and the full charge voltage value may be adjusted to a lower value as the number of accumulated temperature imbalance occurrences increases.

In a process of charging the battery cells after the first control operation, when an event in which at least one of the conditions satisfied for the first control operation is released occurs, the controller 200 may adjust the downwardly adjusted full charge voltage value upward to a preset voltage value. In other words, after the full charge voltage value is adjusted down according to an occurrence of a temperature imbalance condition and the temperature imbalance condition is released during a charging process, the controller 200 may increase the full charge voltage values of all battery cells to operate at maximum performance. Here, the full charge voltage value may be adjusted to an initially set full charge voltage value (e.g., returning from 4.10V to 5V).

When an event that satisfies at least one of the first condition (T1>Tmax) and the second condition (T1−T2>Td) occurs during the battery cells being in a fully charged state, the controller 200 may perform a second control operation of blocking trickle charge for the plurality of battery cells. In other words, when a temperature imbalance occurs in a fully charged state of battery cells, the controller 200 may block trickle charging of all battery cells to prevent deterioration and performance degradation of battery cells. Here, the controller 200 may block trickle charge by controlling a switch (e.g., C-FET) located in a trickle charge path to be in an OFF state.

When an event in which at least one of the conditions satisfied for the second control operation is released occurs in a state in which trickle charge of the plurality of battery cells is blocked according to the second control operation, the controller 200 may allow trickle charge for a plurality of batteries. In other words, when the temperature imbalance state is released after the trickle charge is blocked due to an occurrence of the temperature imbalance in a fully charged state of the batteries, the controller 200 may permit trickle charge of all the battery cells to compensate for micro-discharge due to current consumption of the system. Here, the controller 200 may allow trickle charge by controlling a switch (e.g., C-FET) located in a trickle charge path to be in an ON state.

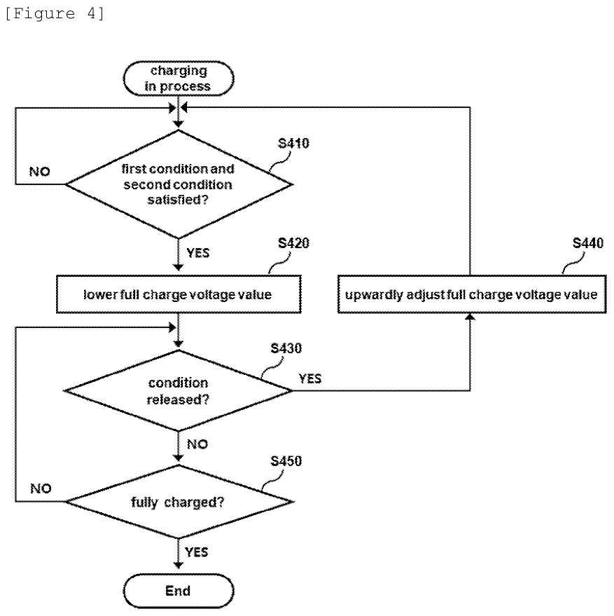

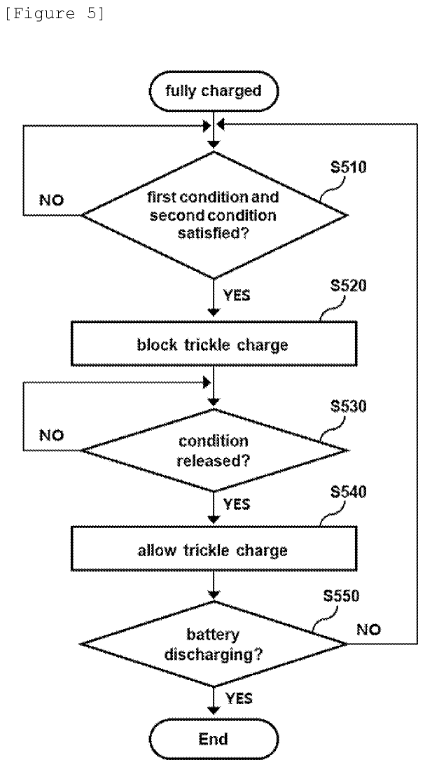

Hereinafter, a control method of a battery control system according to embodiments of the present invention will be described with reference to FIGS. 4 and 5.

A control method of a battery control system according to embodiments of the present invention may be performed by a control apparatus 200 interworking with temperature measuring units 110 and 120 that measure a temperature of a first battery cell disposed at a first point and a temperature of a second battery cell disposed at a second point which is spaced apart from the first point.

With reference to FIG. 4, a control process in a state of battery charging will be described.

The first temperature sensor 110 may measure a temperature T1 of the battery cell 10-1 disposed in the highest temperature environment and the second temperature sensor 120 may measure a temperature T2 of the battery cell 10-3 disposed in the lowest temperature environment.

The control apparatus 200 may receive temperature measurement values of the first battery cell and the second battery cell from the first and second temperature sensors 110 and 120 at predetermined time intervals and monitor temperatures (T1, T2) of the first battery cell and the second battery cell.

The control apparatus 200 may check if at least one of a first condition and a second condition is satisfied to determine whether a temperature imbalance state between battery cells has occurred (S410), wherein the first condition is a condition in which the temperature T1 of the first battery cell exceeds a predefined upper temperature limit value Tmax (T1>Tmax); and the second condition is a condition in which a difference between the temperature T1 of the first battery cell and the temperature T2 of the second battery cell exceeds a predefined reference difference value Td (T1−T2>Td). Here, the control apparatus 200 may determine that a temperature imbalance between battery cells has occurred when both the first and second conditions are satisfied.

When an event that satisfies both the first condition and the second condition occurs, the control apparatus 200 may lower the full charge voltage value of the plurality of battery cells to a predefined voltage value (perform the first control operation) (S420). In other words, when a temperature imbalance occurs during a charge process of the battery cells, the control apparatus 200 may reduce the full charge voltage values of all battery cells (e.g., from 5V to 4.10V) to minimize performance imbalance of the battery cells.

Thereafter, the control apparatus 200 may check whether an event in which at least one of the first and second conditions is released occurs (S430). Here, the control apparatus 200 may determine that the temperature imbalance between the battery cells is resolved when both the first and second conditions are released.

When an event in which both the first and second conditions are released occurs, the control apparatus 200 may upwardly adjust the lowered full charge voltage value to a predefined voltage value (S440). Here, the full charge voltage value may be adjusted to the initially set full charge voltage value (e.g., return to 5V from 4.10V), and thus, all battery cells may operate at maximum performance.

If an event in which both the first and second conditions are released does not occur, the control apparatus 200 checks whether the battery is fully charged (S450). If the battery is not in a fully charged state, it returns to step S430 of checking whether the first and second conditions are released, and if the battery is in a fully charged state, the control process ends.

Next, referring to FIG. 5, a control process in a fully charged state of the battery will be described. Meanwhile, the fully charged state of the battery means a state in which battery cells are charged to a full charge voltage value (an initial set value, a value adjusted downward by the first control operation, or a value adjusted upward after the first control operation).

The first temperature sensor 110 measures a temperature T1 of the battery cell 10-1 disposed in the highest temperature environment and the second temperature sensor 120 measures a temperature T2 of the battery cell 10-3 disposed in the lowest temperature environment.

The control apparatus 200 may receive temperature measurement values of the first battery cell and the second battery cell from the first and second temperature sensors 110 and 120 at predetermined unit time intervals, and monitor the battery cell temperatures (T1, T2).

The control apparatus 200 may check whether at least one of the first condition (T1>Tmax) and the second condition (T1−T2>Td) is satisfied to determine whether a temperature imbalance state between battery cells has occurred (S510). Here, the control apparatus 200 may determine that a temperature imbalance between battery cells has occurred when both the first and second conditions are satisfied.

When an event that satisfies both the first condition and the second condition occurs, the control apparatus 200 may block trickle charge of the plurality of battery cells (perform a second control operation) (S520). In other words, when a temperature imbalance occurs in a fully charged state of battery cells, the control apparatus 200 may block trickle charge of all battery cells to prevent deterioration and degradation of battery cells.

Thereafter, the control apparatus 200 may check whether an event in which at least one of the first and second conditions is released occurs (S530). Here, the control apparatus 200 may determine that the temperature imbalance between the battery cells is resolved when both the first and second conditions are released.

When an event in which both the first and second conditions are released occurs, the control apparatus 200 may allow trickle charge of the plurality of battery cells (S540). In other words, when the temperature imbalance state is released, the controller 200 may permit trickle charging of all battery cells to compensate for micro-discharge due to system current consumption.

After trickle charging is allowed, the control apparatus 200 may check whether the battery cells are in a discharging state due to supplying power to a system (S550). It may return to step S510 of checking whether a temperature imbalance state between the battery cells has occurred in the instance that the battery is not in a discharged state and the control process may be terminated in the instance that the battery is in a discharged state.

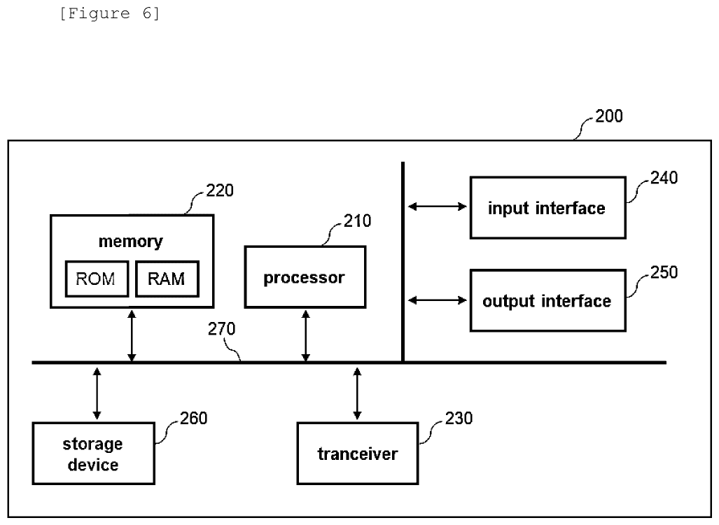

FIG. 6 is a block diagram of a battery control apparatus according to embodiments of the present invention.

Hereinafter, main elements of the control apparatus 200 for performing a control method according to embodiments of the present invention will be described with reference to FIG. 6.

The control apparatus 200 according to embodiments of the present invention may interwork with temperature measurement units 110 and 120 that measure a temperature of a first battery cell disposed at a first point and a temperature of a second battery cell disposed at a second point and may include at least one processor 210, a memory 220 for storing at least one command executed by the at least one processor, and a transceiver 230 for communicating with other components in the battery control system.

The control apparatus 200 according to embodiments of the present invention may be implemented by being included in a battery management system (BMS) or an energy management system (EMS), but the scope of the present invention is not limited to these entities.

The at least one instruction executed by the at least one processor may include: an instruction to monitor the temperature of the first battery cell and the temperature of the second battery cell; and an instruction to perform a predefined control operation for preventing state degradation due to temperature imbalance between the battery cells based on at least one of the temperature of the first battery cell and the temperature of the second battery cell.

The instruction to perform the predefined control operation may include an instruction to perform the predefined control operation according to whether or not the at least one of a first condition and a second condition is satisfied.

The instruction to perform the predefined control operation may include an instruction to, in the instance that an event satisfying at least one of the first condition and the second condition occurs while the plurality of battery cells are being charged, perform a first control operation of lowering a full charge voltage of the plurality of battery cells to a predetermined voltage value.

The instruction to perform the predefined control operation may include an instruction to, in the instance that an event in which at least one of the satisfied conditions while the plurality of battery cells are being charged is released occurs after the first control operation, increase the lowered full charge voltage value to a predefined voltage value.

The instruction to perform the predefined control operation may include an instruction to, in the instance that an event satisfying at least one of the first condition and the second condition occurs in a fully charged state of the plurality of battery cells, perform a second control operation to block trickle charge for the plurality of battery cells.

The instruction to perform the predefined control operation may include an instruction to, in the instance that an event in which at least one of the satisfied conditions is released occurs in a state in which the trickle charge for the plurality of battery cells is blocked after the second control operation, allow trickle charge for the plurality of battery cells.

The control apparatus 200 may further include an input interface 240, an output interface 250, a storage device 260, and the like. Each component included in the control apparatus 200 may be connected by a bus 270 to communicate with each other.

Here, the processor 210 may mean a central processing unit (CPU), a graphics processing unit (GPU), or a dedicated processor for performing methods according to embodiments of the present invention. The memory (or storage device) may be composed of at least one of a volatile storage medium and a non-volatile storage medium. For example, the memory may include at least one of read only memory (ROM) and random access memory (RAM).

The operations of the method according to the embodiments of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system to store and execute computer-readable programs or codes in a distributed manner.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus. Some or all of the method steps may be performed by (or using) a hardware device, such as, for example, a microprocessor, a programmable computer, or an electronic circuit. In some embodiments, one or more of the most important method steps may be performed by such an apparatus.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1. A battery control system comprising:
a temperature measuring device configured to measure a temperature of a first battery cell disposed at a first point among a plurality of battery cells included in a battery assembly, and a temperature of a second battery cell disposed at a second point among the plurality of battery cells, wherein the second point is spaced apart from the first point; and
a controller configured to:
monitor the temperature of the first battery cell and the temperature of the second battery cell, and
perform a predefined control operation for preventing state degradation due to temperature imbalance among the plurality of battery cells based on at least one of the temperature of the first battery cell and the temperature of the second battery cell.

2. The battery control system of claim 1, wherein the first point corresponds to a location having a higher instantaneous temperature value or a higher average temperature value than that of the second point.

3. The battery control system of claim 2, wherein the first point corresponds to a location having a highest instantaneous temperature value or a highest average temperature value in the battery assembly, and
wherein the second point corresponds to a location having a lowest instantaneous temperature value or a lowest average temperature value within the battery assembly.

4. The battery control system of claim 1, wherein the controller is configured to perform the predefined control operation according to whether or not the at least one of a first condition and a second condition is satisfied,
wherein the first condition is the temperature of the first battery cell exceeding a predefined upper temperature limit, and
wherein the second condition is a difference between the temperature of the first battery cell and the temperature of the second battery cell exceeding a predetermined reference difference value.

5. The battery control system of claim 4, wherein the controller is configured to:
when an event satisfying at least one of the first condition and the second condition occurs during charging of the plurality of battery cells,
perform a first control operation of lowering a full charge voltage of the plurality of battery cells to a first predetermined voltage value.

6. The battery control system of claim 5, wherein the controller is configured to:
when an event in which at least one of the satisfied conditions during charging of the plurality of battery cells is released occurs after the first control operation,
increase the lowered full charge voltage value to a second predefined voltage value.

7. The battery control system of claim 4, wherein the controller is configured to:
when an event satisfying at least one of the first condition and the second condition occurs in a fully charged state of the plurality of battery cells,
perform a second control operation to block trickle charging for the plurality of battery cells.

8. The battery control system of claim 7, wherein the controller is configured to:
when an event in which at least one of the satisfied conditions is released occurs in a state in which the trickle charging for the plurality of battery cells is blocked, after the second control operation,
allow trickle charging for the plurality of battery cells.

9. A battery control apparatus connected with a temperature measuring device configured to measure a temperature of a first battery cell disposed at a first point among a plurality of battery cells included in a battery assembly and a temperature of a second battery cell disposed at a second point among the plurality of battery cells, wherein the second point is apart from the first point, the battery control apparatus comprising:
at least one processor; and
a non-transitory memory configured to store at least one instruction executed by the at least one processor,
wherein the at least one instruction includes:
an instruction to monitor the temperature of the first battery cell and the temperature of the second battery cell; and
an instruction to perform a predefined control operation for preventing state degradation due to temperature imbalance between the plurality of battery cells based on at least one of the temperature of the first battery cell and the temperature of the second battery cell.

10. The battery control apparatus of claim 9, wherein the first point corresponds to a location having a higher instantaneous temperature value or a higher average temperature value than that of the second point.

11. The battery control apparatus of claim 10, wherein the first point corresponds to a location having a highest instantaneous temperature value or a highest average temperature value in the battery assembly, and
wherein the second point corresponds to a location having a lowest instantaneous temperature value or a lowest average temperature value within the battery assembly.

12. The battery control apparatus of claim 9, wherein the instruction to perform the predefined control operation includes an instruction to:
perform the predefined control operation according to whether or not the at least one of a first condition and a second condition is satisfied,
wherein the first condition is the temperature of the first battery cell exceeding a predefined upper temperature limit, and
wherein the second condition is a difference between the temperature of the first battery cell and the temperature of the second battery cell exceeding a predetermined reference difference value.

13. The battery control apparatus of claim 12, wherein the instruction to perform the predefined control operation includes an instruction to:
when an event satisfying at least one of the first condition and the second condition occurs during charging of the plurality of battery cells,
perform a first control operation of lowering a full charge voltage of the plurality of battery cells to a first predetermined voltage value.

14. The battery control apparatus of claim 13, wherein the instruction to perform the predefined control operation includes an instruction to:
when an event in which at least one of the satisfied conditions during charging of the plurality of battery cells is released occurs, after the first control operation,
increase the lowered full charge voltage value to a second predefined voltage value.

15. The battery control apparatus of claim 12, wherein the instruction to perform the predefined control operation includes an instruction to:
when an event satisfying at least one of the first condition and the second condition occurs in a fully charged state of the plurality of battery cells,
perform a second control operation to block trickle charging for the plurality of battery cells.

16. The battery control apparatus of claim 15, wherein the instruction to perform the predefined control operation includes an instruction to:
when an event in which at least one of the satisfied conditions is released occurs in a state in which the trickle charging for the plurality of battery cells is blocked, after the second control operation,
allow trickle charging for the plurality of battery cells.

17. A control method of a battery control system including a temperature measuring device configured to measure a temperature of a first battery cell disposed at a first point among a plurality of battery cells included in a battery assembly and a temperature of a second battery cell disposed at a second point among the plurality of battery cells, wherein the second point is spaced apart from the first point, and a control apparatus configured to perform a predefined control operation based on the temperature of the first battery cell and the temperature of the second battery cell, the control method comprising:
monitoring the temperature of the first battery cell and the temperature of the second battery cell; and
performing a predefined control operation for preventing state degradation due to temperature imbalance between the plurality of battery cells based on at least one of the temperature of the first battery cell and the temperature of the second battery cell.

18. The control method of claim 17, wherein the performing the predefined control operation includes:
performing the predefined control operation according to whether or not the at least one of a first condition and a second condition is satisfied,
wherein the first condition is the temperature of the first battery cell exceeding a predefined upper temperature limit and the second condition is a difference between the temperature of the first battery cell and the temperature of the second battery cell exceeding a predetermined reference difference value.

19. The control method of claim 18, wherein the performing the predefined control operation includes:
when an event satisfying at least one of the first condition and the second condition occurs during charging of the plurality of battery cells,
performing a first control operation of lowering a full charge voltage of the plurality of battery cells to a first predetermined voltage value.

20. The control method of claim 19, wherein the performing the predefined control operation further includes:
when an event in which at least one of the satisfied conditions during charging of the plurality of battery cells is released occurs, after the first control operation,
increasing the lowered full charge voltage value to a second predefined voltage value.

21. The control method of claim 18, wherein the performing the predefined control operation includes:
when an event satisfying at least one of the first condition and the second condition occurs in a fully charged state of the plurality of battery cells,
performing a second control operation to block trickle charging for the plurality of battery cells.

22. The control method of claim 21, wherein the performing the predefined control operation includes:
when an event in which at least one of the satisfied conditions is released occurs in a state in which the trickle charging for the plurality of battery cells is blocked, after the second control operation,
allowing trickle charging for the plurality of battery cells.
